(19) United States
(12) Patent Application Publication
(10) Pub. No.: US 2022/0206720 A1
(43) Pub. Date: Jun. 30, 2022

(54) Tracking, Destroying Data, Containing Mechanism for Magnetic, Solid-State, and Other Types of Data Bearing Devices

(71) Applicant: Sepehr Rajaie, Reynoldsburg, OH (US)

(72) Inventor: Sepehr Rajaie, Reynoldsburg, OH (US)

(21) Appl. No.: 17/139,988

(22) Filed: Dec. 31, 2020

(51) Int. Cl. G06F 3/06

(52) U.S. Cl. CPC G06F 3/0679; G06F 3/0604; G06F 3/0652

(57) ABSTRACT

The current invention is a Tracking, Destroying Data, Containing Mechanism for Magnetic, Solid-State, and Other Types of Data Bearing Devices. This secure mechanism includes a system that tracks solid state, magnetic, and other types of data bearing devices by enrolling them with unique identification information into a secure database. Then the data bearing device is inserted into the secure mechanism, and the unique identification information is scanned within the secure mechanism and recorded into the secure data base. The data is destroyed immediately and the remains with evidence that is legible are contained within the secure mechanism for reconciliation and verification. This secure mechanism includes a filtration system to preserve air quality where it is located.

### CROSS-REFERENCES TO RELATED APPLICATIONS (IF ANY)

None

### BACKGROUND

### 1. Field of the Invention

The present invention relates to a process for tracking and destroying data or magnetic, solid-state and other types of data bearing devices.

### 2. Description of Prior Art

Data bearing devices that eventually fail or are decommissioned are separated from the host server or array or other computer device and need to be tracked, have data destroyed immediately, and be contained with evidence that is legible until reconciliation and verification.

Other systems may not have secure methods for tracking. Other systems may not destroy data on multiple types of data bearing devices. Other systems may not destroy data immediately. Other systems may not be used within an organization's secure location. Other systems may not contain data bearing devices with data destroyed with evidence that is legible for reconciliation and verification. Other systems may reduce air quality in the areas where they are being used.

There is still room for improvement in the art.

### SUMMARY OF THE INVENTION

The present invention is a secure mechanism that includes a system that tracks solid state, magnetic, and other types of data bearing devices by enrolling them with unique identification information into a secure database. Then the data bearing device is inserted into the secure mechanism, and the unique identification information is scanned within the secure mechanism and recorded into the secure data base. The data is destroyed immediately and the remains with evidence that is legible are contained within the secure mechanism for reconciliation and verification. This secure mechanism includes a filtration system to preserve air quality where it is located.

It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a diagram of some of the components of the invention; and

FIG. 2 shows a flowchart of the invention.

### DESCRIPTION OF THE PREFERRED EMBODIMENT

There are a number of significant design features and improvements incorporated within the invention.

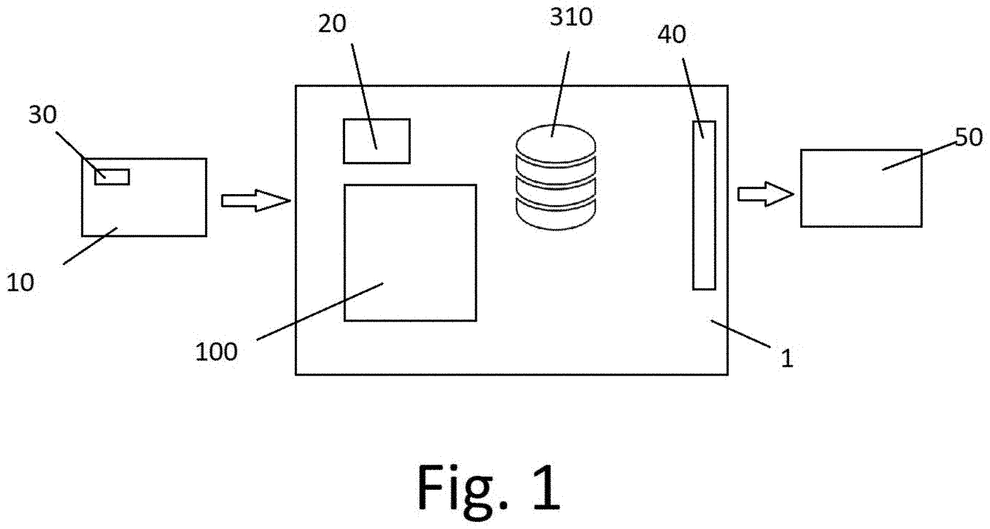

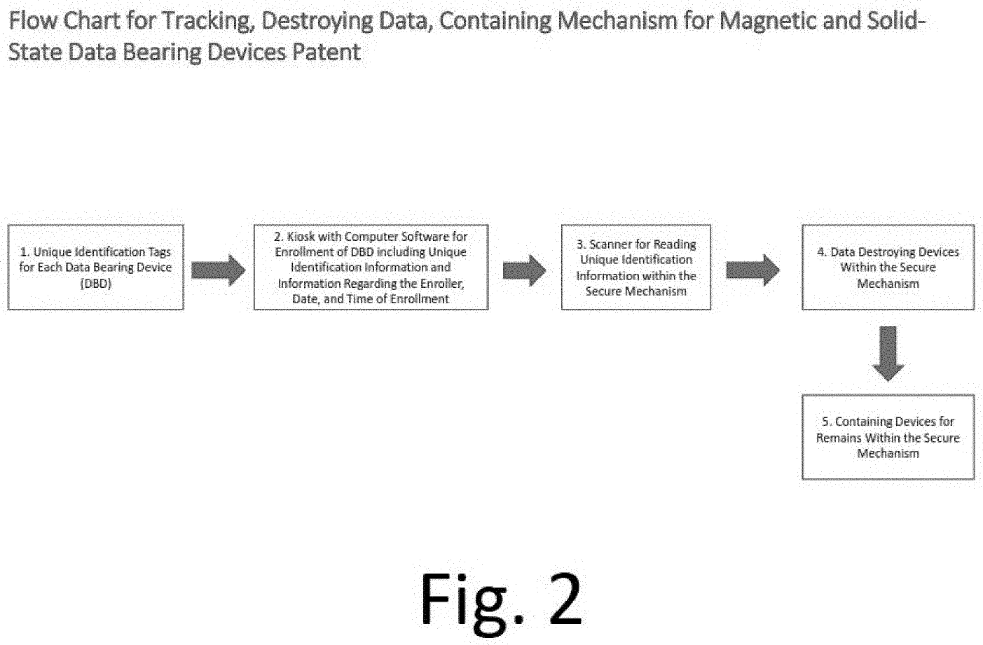

As shown in FIGS. 1 and 2, the present invention is a secure mechanism 1 that includes tracking with unique identification, scanning of unique identification within the secure mechanism 1, destroying data immediately on multiple types of data bearing devices 10, and containing the remains of failed or decommissioned solid state, magnetic and other types of data bearing devices 10 with data destroyed with evidence that is legible for reconciliation and verification within one secure mechanism 1. The secure mechanism 1 includes a filtration system 40 to preserve air quality where it is located. Also, the secure mechanism 1 can be produced in a variety of sizes to match the capacity needed by an organization.

As stated above, data bearing devices 10 that eventually fail or are decommissioned are separated from the host server or array or other computer device and need to be tracked, have data destroyed immediately, and be contained with evidence that is legible until reconciliation and verification. The current invention claimed here solves this problem.

When the failed or decommissioned data bearing device 10 is removed from the host server or array or other computer device, it will be tracked by having a unique identification tag 30 added to it and being enrolled into the secure database 310 through the secure mechanism Kiosk 100 where the data and processing code can reside in the non-transitory memory. Then it is inserted into the secure mechanism 1 to be scanned and recorded into the database 310 and to have the data destroyed immediately. The remains 50 with evidence that is legible are contained within the secure mechanism 1 until a two-person team arrives to reconcile and verify the destruction event.

The claimed invention differs from what currently exists. This secure mechanism 1 includes tracking with unique identification, scanning of unique identification within the secure mechanism 1, destroying data immediately on multiple types of data bearing devices 10, and containing the remains 50 of failed or decommissioned solid state, magnetic and other types of data bearing devices 10 with data destroyed with evidence that is legible for reconciliation and verification within one secure mechanism 1. The secure mechanism 1 includes a filtration system 40 to preserve air quality where it is located. Also, the secure mechanism 1 can be produced in a variety of sizes to match the capacity needed by an organization.

Other systems do not have tracking systems with unique identification for each data bearing device. Other systems destroy data on a single type of data bearing device. Other systems destroy data bearing devices 10 in a location that is outside the secure confines of a data center or enterprise facility which constitutes a security risk. Other systems do not destroy data immediately. Other systems do not contain evidence from data destruction that is legible for reconciliation and verification. Other systems do not focus on preserving air quality in the area where they are used.

As shown in FIG. 1, the current invention has:

1. Unique identification tag 30s for each data bearing device.

2. Kiosk 100 with secure computer software for enrollment of data bearing device 10 including unique identification tag 30 information and information regarding the source location, serial number, enroller, date, and time of enrollment.

3. Scanner 20 within the secure mechanism 1 for reading and recording unique identification information and date and time when inserted into secure database 310

4. Data destroying devices 10 within the secure mechanism 1 to process solid state, magnetic, and other types of data bearing devices

5. System for containing remains 50 of devices 10 with data destroyed with evidence that is legible within the secure mechanism 1 for reconciliation and verification

6. Air filtration system 40

The process as shown in FIG. 2 is as follows:

Step 1-5 are completed in order as listed. Steps 1, 2, and 3 are Tracking. Step 1 begins the process of tracking the data bearing device 10 after the organization has determined a device 10 has reached its end of life. The data on the device 10 is no longer attached to the organization's network system, and if compromised can harm their brand. A unique identification tag 30 is added to the device. Step 2 is using the software of the kiosk computer for enrolling the device 10 by entering unique identification information regarding the data bearing device 10 and the enroller including the host source location (array and server) or other computer location of the device, serial number, unique identification tag 30 30 number, date, time and name of the enroller into the secure database 310. Step 3 tracks the data bearing device 10 by scanning the unique identification tag 30 using a reader within the secure mechanism 1 to record it into the secure database 310 along with the date and time of when the device 10 is inserted into the secure mechanism 1. Step 4 is the destroying of the data on the data bearing device 10 within the secure mechanism 1. Step 5 completes the process by containing the remains 50 of the data bearing devices 10 after the data has been destroyed with evidence that is legible within the secure mechanism 1 until reconciliation and verification.

This secure mechanism 1 requires the organization which uses it to have external certification such as a formal Cyber Security Framework (CSF) that requires verification that the data on data bearing devices 10 that currently hold data or at one time held data is destroyed. This secure mechanism 1 requires a certified secured database 310 to hold information from the organization and from the provider of the secure mechanism 1 to prove that the data on data bearing devices 10 that currently hold data or at one time held data are destroyed. This secure mechanism 1 requires the provider of the secure mechanism 1 to provide unique identification tags 30 to label the data bearing devices 10 and to correlate with information provided by the organization when the data bearing device 10 is enrolled into the secure database 310. This secure mechanism 1 requires a reader to scan the unique identification tag 30 and record this with date and time into the secured database 310 when a data bearing device 10 that currently holds data or at one time held data is inserted into the secure mechanism 1. The secure mechanism 1 requires systems within the secure mechanism 1 to destroy data from various types of data bearing devices 10 while maintaining evidence that is legible for verification. The secure mechanism 1 requires the organization to maintain the secure mechanism 1 as containment of the remains 50 of the data bearing devices 10 with evidence that is legible until reconciliation and verification by a two-person team from the provider of the secure mechanism 1. This invention requires the provider of the secure mechanism 1 to train and certify an organization's designated personnel to properly perform the required steps for use of the secure mechanism 1.

Advantages

By following the secure mechanism's process, an organization can be confident that the data bearing device is tracked, the data on the data bearing device that is holding secure data or at one time held data has been destroyed, and the remains with evidence that is legible are securely contained until reconciliation and verification. This alleviates the potential problem of the organization damaging their brand due to leaks of secure data onto the global network. It solves the insider threat in cybersecurity.

It saves the organization time and effort in marketing and answering claims in the legal system regarding secure data breaches. It helps the organization meet cybersecurity regulations and avoid significant fines for non-compliance.

Additionally: Any organization that wants to securely remove not only digital information, but also immediately destroy mechanical information such as a shape and size of a design would want to use a secure system as described to ascertain that the data no longer exists. Therefore, the process would immediately protect the organization from data security compromise, which would save them from spending time and resources to counteract the loss.

### CONCLUSION

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device of destroying data:
a mechanism with a scanner and a data destroying device within the mechanism with a filtration system.

2. The device according to claim 1 further comprising:
having a kiosk.

3. The device according to claim 1 further comprising:
where the data is on a data bearing device.

4. The device according to claim 3 further comprising:
where each data bearing device has an identification tag.

5. The device according to claim 4 further comprising:
a Kiosk that has computer software for enrollment of information on data bearing device and the identification tag.

6. The device according to claim 5 further comprising:
where the information is one or more from a set of the source location, serial number, enroller, date, and time of enrollment.

7. The device according to claim 5 further comprising:
where the information is stored on a database.

8. The device according to claim 1 further comprising:
having a scanner.

9. The device according to claim 3 further comprising:
containing the remains of the data bearing device.

10. A process to destroy data comprising;
having a data storage device;
having a mechanism;
having the mechanism have a data destroying device in it
placing the data storage device into the mechanism; and
destroying the data storage device.

11. A process according to claim 1 further comprising:
tagging the data storage device with an identification tag.

12. The process according to claim 11 further comprising:
having a Kiosk that has computer software for enrollment of information on data bearing device and the identification tag.

13. The process according to claim 12 further comprising:
where the information is one or more from a set of the source location, serial number, enroller, date, and time of enrollment.

14. The process according to claim 13 further comprising:
storing the information on a database.

15. The device according to claim 10 further comprising:
having a scanner.

16. The device according to claim 10 further comprising:
containing the remains of the data bearing device.
